(19) United States
(12) Patent Application Publication
(10) Pub. No.: US 2007/0131362 A1
(43) Pub. Date: Jun. 14, 2007

(54) Process for producing a fibrous product

(75) Inventors: Johanna Buchert, Espoo (FI); Hannu Mikkonen, Rajamaki (FI); Soili Peltonen, Rajamaki (FI); Liisa Viikari, Helsinki (FI); Stina Gronqvist, Tolkkinen (FI); Tarja Oksanen, Espoo (FI); Anna Suurnakki, Espoo (FI)

Correspondence Address: SUGHRUE MION, PLLC, 2100 PENNSYLVANIA AVENUE, N.W., SUITE 800, WASHINGTON, DC, 20037, US

(73) Assignee: VALTION TEKNILLINEN TUTKIMUSKESKUS, Espoo (FI)

(21) Appl. No.: 10/583,712

(22) PCT Filed: Dec. 23, 2004
(86) PCT No.: PCT/FI04/00795

§ 371 Date: Oct. 2, 2006

(30) Foreign Application Priority Data
Dec. 23, 2003 (FI) 20031903

(51) Int. Cl. D21H 11/20; D21H 21/14; C08F 251/02

(52) U.S. Cl. 162/9; 162/70; 162/72

(57) ABSTRACT

The present invention concerns a process for modifying a lignocellulosic fibre material. In particular, the present invention gives new properties to the fibrous matrix of the material. This is achieved by producing fibrous products with modified properties by activating the fibres of the matrix with an oxidizing agent and attaching compounds to the activated fibre in order to incorporate desired, pre-selected properties in to the fibre matrix. The invention makes possible to produce novel kinds of fibrous materials having practically a large variety of properties. Examples of such properties include hydrophobic hydrophilic character.

### BACKGROUND OF THE INVENTION

1. Field of the Invention

The present invention relates to fibrous products. In particular, the present invention concerns a process for modifying a lignocellulosic fibre material so as to impart new properties to the fibrous matrix of the material.

2. Description of Related Art

Lignocellulosic fibres are chemically only moderately reactive, which makes it difficult to attach new compounds to the fibres to tailor the fibrous matrices for new uses or to impart desired new properties to them without imparing material properties. In addition, due to their hydrophilic nature, lignocellulosic fibre matrices are not readily compatible with hydrophobic substances, such as synthetic polymers.

Various ways of modifying lignocellulosic fibre materials by enzymatic treatments are known in the art. Thus, U.S. Pat. No. 6,187,136 describes a process for altering the surface charge of lignocellulosic fibres by reacting the material with an oxidase in the presence of an added phenolic carboxylic acid in order to increase the negative charge of the material. Due to the increased charge, increased binding of an ionically charged strengthening agent can, according to the patent, be achieved.

U.S. Pat. No. 5,846,788 discloses a process for the manufacture of a lignocellulose-based product, such as fibreboard or particle board, from a lignocellulosic material. The product is produced by treating said lignocellulosic material and a phenolic polysaccharide with an enzyme capable of catalyzing the oxidation of phenolic groups in the presence of an oxidizing agent. It is stated that the phenolic polysaccharide functions as an adhesive/binder and provides boards having good strength properties.

A process for oxidation of the hydroxy groups of a sugar monomer of an oligo- or a polysaccharide is suggested in U.S. Pat. Specification No. 6,087,135. The known process comprises contacting, in an aqueous medium, the oligo- or the polysaccharide with a phenoloxidizing enzyme, together with a hydrogen peroxide source when the phenol-oxidizing enzyme is a peroxidase, and an enhancing agent, whereby an oligo- or a polysaccharide with altered characteristics compared to the native oligo- or polysaccharide is created.

All the above-cited documents teach, basically, processes in which the surface properties originally present in the lignocellulosic material are enhanced. However, even when new functionalities (e.g. carbonyl or carboxyl groups) are produced, such groups are directly derived from the corresponding hydroxyl and carbonyl groups already present on the fibres and no novel functional groups are created, as is the case in U.S. Pat. No. 6,087,135.

U.S. Pat. No. 4,891,415 discloses a graft polymer of lignin and vinyl monomer produced by a continuous process, wherein the vinyl monomer and suitable initiator compound are continuously, but separately, fed to a solution of the lignin. Examples of monomers are acrylic acid, acrylamide, acrylonitrile, methacrylic acid, methyl methacrylic acid, maleic acid and vinyl acetate. The initiator is hydrogen peroxide, organic peroxide or persulphate. The graft copolymers have low solution viscosity and good dispersant properties making them suitable for dispersion, scale control and flocculation applications.

A procedure to produce lignocellulosic anion exchangers from agricultural waste materials is described by Orlando, U.S. et. al. (Bioresource Technology, 83 (2002) 195-198). Agricultural waste materials, sugarcane bagasse and rice hull were converted into weak-base anion exchanger and evaluated for their exchanger capacity for nitrate. Pure cellulose and alkali lignin were used as reference materials. Epoxy and amino groups were introduced into the agricultural substrates after the reaction with epichlorohydrin and dimethylamine in the peresence of pyridine (catalyst) and an organic solvent N,N-dimethylformamide. Amino group incorporation into cellulose decreased with the presence of water in the reaction mixture and increased with the reaction time and presence of a catalyst. The highest maximum nitrate exchange capacity and yields was obtained from alkali lignin, followed by sugarcane bagasse, pure cellulose and rice hull.

Cellulose fibre-supported pH-sensitive hydrogels were prepared (Karlsson, J. O. and Gatenholm, P., Polymer 40 (1999) 379-387) by ozone-induced graft polymerisation of acrylic acid using cotton linters and wood pulp fibre substrates. An average amount of grafting of 60% was achieved on to the ozonized wood pulp fibres after 1 min of graft polymerisation. Grafted polyacrylic acid completely covered the cellulose fibre surfaces, as determined with electron spectroscopy for chemical analysis (ESCA) and scanning electron microscopy (SEM). The X-ray mapping of neutralized grafted fibres showed that polyacrylic acid was present not only at the surface but was also homogeneously distributed within the pores of the fibres. Exposure of the grafted fibres to alkali and subsequent drying resulted in a irrevesible deformation of the fibre-supported hydrogel. A fibre-supported hydrogel, which exhibited reversible swelling and deswelling, was prepared by addition of a bifunctional monomer, ethyleneglycol di-methacrylate, to the monomer solution used for grafting. Such muscle-like expanding and contraction was also stimulated by pH changes in the environment.

Acrylic acid was grafted to cellulose by using ceric ammonium nitrate initator in aqueous nitric acid solution (Gülten Gürdag, Muzaffer Yasar and M. Ali Gürkaynak, J. Appl. Polymer Sci., 66 (1997) 927-934). The reaction temperature varied in the range from 30° C. to 90° C. and the reaction time from 30 min to 180 min. It was observed that monomer conversion increases as reaction temperature increases and grafting yield decreases as reaction temperature decreases. The maximum grafting yield was obtained at 30° C. This material had also the highest water retention capacity. High temperature favours homo-polymerisation more than grafting. The step determining the overall activation energy is propagation step in this grafting reaction.

Synthesis of cellulose polyacrylonitrile copolymers is studied in a homogeneous solution of N,N-dimethylacetamide/LiCl (Estella Bianchi, Enrico Marsano, Laura Ricco and Saverio Russo, Carbohydrate Polymers 36 (1998) 313-318). The reaction is based on the preliminary reaction of a portion of hydroxyl groups of cellulose with acryloyl chloride to give cellulose with certain number of pendant double bonds. Successively, acrylonitrile is grafted onto the unsaturated groups by free radical polymerisation using azobisisobutyronitrile as initiator.

The homogeneous grafting of methyl methacrylate onto methacrylate-modified cellulose was achieved by a two-step process at different temperatures in the range 40-70° C. In the first reaction step, a known amount of pendant double bonds is introduced onto cellulose by using methacroyl chloride. Subsequently, the unsaturated monomer, methyl methacrylate is grafted onto cellulose by the action of a suitable initiator, azobisisobutyronitrile.

The reaction temperature and time, the amount of pendant methacrylate groups and the amount of methylmethacrylate and initiator influenced the grafting yield and efficiency. (E. Bianchi, A. Bonazza, E. Marsano and S. Russo, Carbohydrate Polymers 41(2000) 47-53).

To complete the survey, it can be noted that Published EP Patent Application No. 1 106 732 discloses a method for oxidizing cellulose with TEMPO to produce aldehyde modified cellulose pulp, which can be used for producing paper. U.S. Pat. No. 6,319,361 teaches a similar method wherein hydroxylic groups of galactose and mannose units of polysaccharides are oxidized to give rise to aldehyde groups.

None of the cited references provides a route, which would be generally applicable for introducing any desired property to fibres. In particular, there is still a need for methods of introducing new properties directly to fibres, i.e. to equip the fibre matrix with properties, which are foreign to the native fibre. Such properties include, for example, color, stability of the color, resistance to bacterial and fungal degradation, altered surface charge(s), hydrophobic properties, antibacterial properties, compatibility with inorganic materials, conductivity, special signaling agents, active gas traps, barrier properties.

### SUMMARY OF THE INVENTION

It is an aim of the present invention to eliminate the problems of the prior art and to provide a novel way of functionalizing fibres or other wood based materials, in particular cellulosic or lignocellulosic fibres derived from plant materials.

It is a particular aim of the present invention to create cellulosic or lignocellulosic fibres with novel functional properties.

The invention is based on the idea of producing fibrous products with modified properties by activating the fibres of the matrix with an oxidizing agent capable of oxidizing phenolic or similar structural groups, and attaching compounds to the activated fibre in order to incorporate desired, pre-selected properties into the fibre matrix. The activation is carried out either enzymatically, in manners similar to those described in the above-cited patents, or chemically, by mixing the fibres with an oxidizing agent.

According to the invention, fibres activated as described above are contacted with a modifying agent. The modifying agent has at least one functional site, which provides for binding of the modifying compound to the lignocellulosic fibre material, in particular at the oxidized phenolic groups or corresponding chemical structures of the fibres, which have been oxidized during the activation step. In order to introduce to the fibres novel properties, the modifying agent can be of a kind which as such has certain desired properties, such as a specific colour, or which develops such properties when it is attached to the fibres. This basic embodiment is called “Alternative 1” in the below description.

However, the modifying agent can also comprise at least one second functional site, which provides desired properties to the fibre. Such a second functional site can, for example, comprise a hydrophobic hydrocarbon tail, which efficiently reduces the hydrophilic character of the surface of the lignocellulosic fibre making them more compatible with hydrophobic compounds and polymers. This second functional site differs from the ones disclosed in the above-cited references in the sense that it imparts to the fibres new properties, which are foreign to the native fibre. This embodiment is called “Alternative 2” below.

Further, the second functional site can comprise a functional group capable of reacting with still a further component. In such a case, the second functional site constitutes a bonding surface, to which a pre-selected functional agent can be attached to impart novel properties to the fibre matrix (in the following “Alternative 3”). Such properties are formed by the functional agent as such, by the combination of the modifying agent and the functional agent attached thereto, or by the combination of the modifying agent, the functional agent attached thereto and the fibres. In all of these cases, the modifying agent and the second functional site form a binding surface or a “tag” on the fibre matrix at the oxidized sites of the fibres. Once such a tag has been formed onto the fibres of the matrix by the modifying agent, in the method according to the present invention, the tagged fibres are contacted with a functional agent to achieve bonding of the functional agent to the fibres.

Based on the above, the present invention provides a process for producing a fibre material having a modified structure comprising a lignocellulosic fibrous matrix with phenolic or similar structural groups and a modifying agent, comprising three basic alternatives, viz. a first one including the steps of
oxidizing phenolic or similar structural groups of the lignocellulosic matric to provide an oxidized fibre material, and
contacting the oxidized fibre material with a modifying agent containing at least one first functional site, which is reactive with the oxidized fibre material, said modifying agent being capable of providing the lignocellulosic fibre material with properties foreign to the native fibre.

The second alternative includes the steps of
oxidizing phenolic or similar structural groups of the lignocellulosic matric to provide an oxidized fibre material, and
contacting the oxidized fibre material with a modifying agent containing at least one first functional site, which is compatible with the oxidized fibre material, and at least one second site having new functional properties in order to provide a lignocellulosic fibre material having a modified surface exhibiting properties foreign to the native fibre.

The third alternative includes the steps of
oxidizing phenolic or similar structural groups of the lignocellulosic matric to provide an oxidized fibre material,
contacting the oxidized fibre material with a modifying agent containing at least one first functional group, which is compatible with the oxidized fibre material, and at least one second functional group in order to provide a lignocellulosic fibre material having a modified surface,
contacting the thus modified lignocellulosic fibre material with a functional agent, and
bonding the functional agent to the modified surface of the fibre material in order to impart to the fibre material new functional properties derivable from the functional agent.

In each of the alternatives, the oxidation steps can be performed by reacting the lignocellulosic fibrous matrix with an oxidizing agent in the presence of a substance capable of catalyzing the oxidation of phenolic or similar structural groups by said oxidizing agent to provide the oxidized fibre material. The oxidizing agents can be chemical or enzymatical. The oxidation can also be carried out by radiation.

In one particularly preferred embodiment, the lignocellulosic fibrous matrix is provided with an organic substance, which is capable of rendering the fibre a white colour. Such substances (in the following also “whitening agents”) are exemplified by betuline, betulinol, kaempherol and quercetin or their derivatives and analogues, although this list is not by any means exhaustive.

More specifically, the present invention is mainly characterized by what is stated in the characterizing parts of claims 1, 6 and 16.

The method of producing white fibres is characterized by what is stated in the characterizing part of claim 31.

The present invention provides important advantages. Importantly, the invention makes it possible to produce novel kinds of fibrous materials having practically any of a large variety of desired properties. Such properties include hydrophobic/hydrophilic character, antibacterial properties, properties related to the desired colour and to the bonding of an electric charge, especially a positive charge, of the fibres, compatibility with inorganic materials, special signaling agents, active gas traps, barrier properties. In general, practically any desired new properties and functionalities, which have not been found on the fibres before, can be imparted on the fibres by the present invention.

Based on the above, the fibrous matrices can be tailor-made for different end uses.

In the present invention, phenolic groups (or similar structures) on lignin containing material are first selectively oxidized and then a modifying agent is contacted with the oxidized substance. As a result, lignin, which in the preparation of fibrous products generally is an undesirable component or at least an inert component can be modified and coverted such that new and attractive properties can be incorporated to the fibers via it. The oxidation step of the first stage of the invention does not, since it is directed towards the phenolic groups of the lignin, impair the properties of the fibres.

The invention comprises several particularly interesting applications, viz. the production of technical composite materials having improved strength properties, and of conductive lignocellulosic fibres, in which an electrically conductive polymer is reliably attached to the fibres. Theses embodiments are described in more detail in our co-pending patent applications titled: “Process for Producing Fibre Composites” and “Process of Producing a Fibre Composition”. As explained in the co-pending application concerning fibre composites, by bonding a modifying hydrophobic hydrocarbon tail to an oxidized lignocellulosic fibre matrix, improved compatibility between the fibre and a hydrophobic polymer can be attained. As a result, the composite thus produced will exhibit good strength properties. In case of “in situ” polymerization of an electrically conductive polymer, particularly good conductivity and adhesion between the fibre matrix and the polymer is achieved when monomer is polymerized directly on the fibre.

The alternative of colouring lignocellulosic fibres white by use of a whitening agents will effectively reduce both the need for bleaching chemicals and the risk of brightness reversion.

Further details and advantages of the invention will become apparent from the following detailed description and the appended working examples.

### BRIEF DESCRIPTION OF THE DRAWINGS

FIG. 1 depicts in graphical form the hydrophobicity of TMP pulp treated according to the invention compared to a reference sample. Hydrophobicity is expressed as contact angle measured after laccase catalysed bonding of 3,4,5-trihydroxybenzoic acid dodecyl acid ester (∘), after treatment with only 3,4,5-trihydroxybenzoic acid dodecyl acid ester (□) and after reference treatment without any enzyme or 3,4,5-trihydroxybenzoic acid dodecyl acid ester additon (X).

### DETAILED DESCRIPTION OF THE INVENTION

As mentioned above, the invention generally relates to a method of producing wood based structures, especially fibre compositions with new properties, which are not encountered in native fibres.

The wood material such as a fibre matrix comprises fibres containing phenolic or similar structural groups, which are capable of being oxidized by suitable oxidizing agents. Such fibres are typically “lignocellulosic” fibre materials, which include fibre made of annual or perennial plants or wooden raw material by, for example, mechanical, chemimechanical or chemical pulping. During industrial refining of wood by, e.g., refiner mechanical pulping (RMP), pressurized refiner mechanical pulping (PRMP), thermomechanical pulping (TMP), groundwood (GW) or pressurized groundwood (PGW) or chemithermomechanical pulping (CTMP), a woody raw material, derived from different wood species, is refined into fine fibres in processes which separate the individual fibres from each other. The fibres are typically split between the lamellas along the interlamellar lignin layer, leaving a fibre surface, which is at least partly covered with lignin or lignin-compounds having a phenolic basic structure. Such fibres are particularly useful as a matrix for the novel products.

Within the scope of the present invention, also all chemical pulps are included. Advantageously, the chemical pulps that are used as fibre material have a residual content of lignin sufficient to give at least a minimum amount of phenolic groups necessary for providing binding sites for the modifying agent. Generally, the concentration of lignin in the fibre matrix should be at least 0.1 wt-%, preferably at least about 1.0 wt-%.

Also wood and wood-based material is regarded as fibre material in the context of the present invention.

In addition to paper- and paperboard-making pulps of the above kind, also other kinds of fibres of plant origin can be used, such as bagasse, jute, flax and hemp. Synthetic fibres can also used as fibre material according to the present invention. In general, all fibres that can be activated can be used as fibre material.

In the first stage of the present process, the lignocellulosic fibre material is reacted with a substance capable of catalyzing the oxidation of phenolic or similar structural groups to provide an oxidized fibre material. Typically, the substance is an enzyme and the enzymatic reaction is carried out by contacting the lignocellulosic fibre material with an oxidizing agent, which is capable—in the presence of the enzyme—of oxidizing the phenolic or similar structural groups to provide an oxidized fibre material. Such oxidizing agents are selected from the group of oxygen and oxygen-containing gases, such as air, and hydrogen peroxide. Oxygen can be supplied by various means, such as efficient mixing, foaming, air enriched with oxygen or oxygen supplied by enzymatic or chemical means, such as peroxides to the solution. Peroxides, such as hydrogen peroxide can be added in situ. Although any oxygen-containing gas can be used, it is preferred to use ambient air, oxygen enriched air, oxygen gas, pressurized systems of these or oxygen releasing chemicals.

According to an embodiment of the invention, the oxidative enzymes capable of catalyzing oxidation of phenolic groups, are selected from, e.g. the group of phenoloxidases (E.C.1.10.3.2 benzenediol:oxygen oxidoreductase) and catalyzing the oxidation of o- and p-substituted phenolic hydroxyl and amino/amine groups in monomeric and polymeric aro-matic compounds or carbohydrate oxidases (e.g. galactose oxidase, hexose oxidase) catalyzing the oxidation of C₂, C₃ or C₆ in the sample. The oxidative reaction of lignin with the phenoloxidas leads to the formation of phenoxy radicals. Other groups of enzymes comprise the peroxidases and other oxidases. “Peroxidases” are enzymes, which catalyze oxidative reaction using hydrogen peroxide as their electron acceptor, whereas “oxidases” are enzymes, which catalyze oxidative reactions using molecular oxygen as their electron acceptor. The oxidable substrate of these enzymes can be any structural compound of lignocellulosic fibres, preferably lignin or hemicellulose.

In the method of the present invention, the enzyme used may be for example laccase, tyrosinase, peroxidase or oxidase, in particular, the enzyme is selected the group of laccases (EC 1.10.3.2), catechol oxidases (EC 1.10.3.1), tyrosinases (EC 1.14.1 S.1), bilirubin oxidases (EC 1.3.3.5), horseradish peroxidase (EC 1.11.1.7), manganase peroxidase (EC.11.1.1.3), lignin peroxidase (EC 1.11.1.14), galactose oxidase (EC 1.1.3.9) and lipoxygenase (EC 1.13.11.12), hexose oxidase (EC 1.1.3.5) and other carbohydrate oxidases.

The amount of the enzyme is selected depending on the activity of the individual enzyme and the desired effect on the fibre. Advantageously, the enzyme is employed in an amount of 0.0001 to 10 mg protein/g of dry matter.

Different enzyme dosages can be used, but advantageously about 1 to 100,000 nkat/g, advantageously 10-500 nkat/g.

The activation treatment is carried out in a liquid medium, preferably in an aqueous medium, such as in water or an aqueous solution, at a temperature of 5 to 100° C., typically about 10 to 85° C. Normally, ambient temperature (room temperature) or a slightly elevated temperature (20-80° C.) is preferred. Normally, ambient temperature (room temperature) or a slightly elevated temperature (25-35° C.) is preferred. The consistency of the pulp is, generally, 0.5 to 95% by weight, typically about 1 to 50% by weight, in particular about 2 to 40% by weight. The pH of the medium is preferably slightly acidic, in particular the pH is about 2 to 10, in the case of phenoloxidases. Peroxidases are typically employed at a wide pH range, pH of about 3 to 12. The reaction mixture is stirred during oxidation. Other enzymes can be used under similar conditions, preferably at pH 2-10.

The fibres can be treated separately in an aqueous solution or on the formed web

According to another embodiment, the lignocellulosic fibre material is reacted with a chemical oxidizing agent capable of catalyzing the oxidation of phenolic or similar structural groups to provide an oxidized fibre material in the first stage of the process. The chemical oxidizing agent may be a typical, free radical forming substance such as hydrogen peroxide, Fenton reagent, organic peroxidase, potassium permanganate, ozone and chloride dioxide. Examples of suitable salts are inorganic transition metal salts, specifically salts of sulphuric acid, nitric acid and hydrochloric acid. Ferric chloride is an example of suitable salts. Strong chemical oxidants such as alkali metal- and ammoniumpersulphates and organic and inorganic peroxides can be used as oxidising agents in the first stage of the present process. According to an embodiment of the invention, the chemical oxidants capable of oxidation of phenolic groups are selected from the group of compounds reacting by radical mechanism.

According to another embodiment, the lignocellulosic fibre material is reacted with a radical forming radiation capable of catalyzing the oxidation of phenolic or similar structural groups to provide an oxidized fibre material. Radical forming radiation comprises gamma irradiation, electron beam radiation or any high energy radiation capable of forming radicals in a lignocellulose or lignin containing material.

Chemically the wood fibres can be activated by addition of radicalisation agents (e.g chemicals that cleave to form radicals). Normally, ambient temperature (+15 to +20° C.) or lowered temperature −10° C. to +15° C. are preferred, but temperatures of 5 to 100° C., typically about 10 to 85° C. or a slightly elevated temperature (20-80° C.) may be used.

Generally, the first step of the process lasts for about 0.1 minutes to 24 hours, typically about 1 minute to about 10 hours, depending on the oxidizing substance employed. The treatment time can be, for example, about 5 to 240 minutes, in the case of enzymes.

In the second step of the process, a modifying agent is bonded to the oxidized phenolic or similar structural groups of the matrix. Such a modifying agent typically exhibits at least one first functional site, which is compatible with the fibrous matrix, and optionally at least one second functional site, as will be explained in more detail below.

The first functional site comprises in particular functional groups, which are capable of contacting and binding to the fibre at the oxidized phenolic or similar structural groups or at its vicinity.

The bond formed between the oxidized phenolic or similar residue can be covalent or ionic or even based on hydrogen bonding to the modifying agent. Typical functionalities of the first functional site include reactive groups, such as hydroxyl (including phenolic hydroxy groups), carboxy, anhydride, aldehyde, ketone, amino, amine, amide, imine, imidine and derivatives and salts thereof, to mention some examples. Also electronegative bonds, such as double bonds and oxo or azo -bridges can provide for bonding to the oxidized residues.

It is essential that modifying agent is bonded chemically, physically or by chemi- or physisorption to the fibre matrix to such an extent that at least an essential part of it cannot be removed. One criterion, which can be applied to test this feature, is washing in aqueous medium, because often the fibrous matrix will be processed in aqueous environment, and it is important that it retains the new and valuable properties even after such processing. Thus, preferably, at least 10 mole-%, in particular at least 20 mole-%, and preferably at least 30 mole-%, of the modifying agent remains attached to the matrix after washing or leaching in an aqueous medium.

The interaction of the oxidized lignocellulosic material and the modifying agent, resulting in bonding of the modifying agent to the lignocellulosic material, typically takes place in liquid phase, usually in water or in another aqueous medium. The pulp or other lignocellulosic fibrous matrix is suspended in the medium and it is contacted with the modifying agent or a precursor thereof, which is dissolved or dispersed in the same medium. The conditions can vary freely, although it is preferred to carry out the contacting under mixing or stirring. The temperature is generally between the melting point and the boiling point of the medium; preferably it is about 5 to 60° C. Depending on the modifying agent or its precursor, the pH of the medium can be neutral or weakly alkaline or acidic (pH typically about 2 to 12). It is preferred to avoid strongly alkaline or acidic conditions because they can cause hydrolysis of the fibrous matrix. Normal pressure (ambient pressure) is also preferred, although it is possible to carry out the process under reduced or elevated pressure in pressure resistant equipment. Generally, the consistency of the fibrous material is about 0.5 to 50 % by weight during the contacting stage.

According to a particularly preferred embodiment, the first and the second stages of the process are carried out in the same reaction medium, without separating the fibrous matrix after the oxidation step. The conditions (consistency, temperature, pH, pressure) can, though, even in this embodiment be different during the various processing stages.

According to an embodiment, the modifying agent is activated with an oxidizing agent.

As mentioned above, the modifying agent can be of a kind, which gives the fibres new and interesting properties as such (Alternative 1). Examples of modifying agents of this kind include a large range of hydrophobic agents, colouring agents, pigments, agents capable of dissipating incident radiation, sizing agents, retention agents. Modifying agents of the above kind are, for example, colouring agents, which can be selected e.g. from the group of betuline, betulinol, kaempherol and quercetin or their derivatives and analogies , to mention but a few examples of colouring agents.

The modifying agent can have a plurality of functional sites of the first kind. Typically, there are 1 to 3 first functional groups, although the bonding of the modifying agent to the fibrous matrix would appear to take place mainly through one functional group at the time. One functional site or component may cause several properties to the fiber.

The modifying agent can also have a second functional site, which comprises either functionalities, which render the bonded agent and the fibre substrate to which it is bonded specific properties directly derivable from the second functionality (Alternative 2), or functionalities, which are suitable for attaching a functional agent (Alternative 3), as will be discussed below.

Examples of modifying agents of Alternative 2 are compounds, which comprise a hydrophobic hydrocarbon tail. Such compounds are exemplified by eugenol, isoeugenol and their alkyl derivatives, and alkyl derivatives of gallate—gallic acid, vanilic acid, 3,4-dihydroxy benzoic acid, ferulic acid, caffeic acid vanilyl amine, tyramine, L-Dopa and tyrosine to name but a few examples. All of these comprise at least one functional group, which bonds to the oxidized lignocellulosic materials, and a hydrocarbon tail, which is saturated or unsaturated. Typically, the hydrocarbon tail contains a minimum of two, preferably at least three carbon atoms, and extends to up to 30 carbon atoms, in particular 24 carbon atoms. Such chains can be the residues of fatty acids bonded to the core of the modifying agent. As mentioned above, the hydrophobic tail can be utilized for the preparation of composites comprising a hydrophobic polymer, which is reinforced with fibres of plant origin.

Another example are modifying agents comprising groups capable of carrying or capable of being modified for carrying a negative or positive charge. Further examples are the following:
groups capable of carrying or capable of being modified for carrying a negative or positive charge, e.g. vanillyl amine, tyramine , L-Dopa and tyrosine)
groups capable of carrying or capable of being modified for antibacterial, antifungal or antimicrobial effect,
groups capable of carrying or capable of being modified for hydrophilic or hydrophobic character,
groups capable of carrying or capable of being modified for heatproof, flame-retardant or UV-resistant,
groups capable of carrying or capable of being modified for conductive, antistatic, insulative character or is acting as a sensor,
groups capable of carrying or capable of being modified for changing the colour of the fibre,
groups comprising properties that participate in developing colour,
groups capable of carrying or capable of being modified for oxygen/gas barrier properties,
groups capable of carrying or capable of being modified for inhibition of brightness reversion, and
several properties in one compound e.g. white and hydrophobic.

Examples of modifying agents of Alternative 3 are compounds, which can be characterized as being “bifunctional”, i.e. compounds containing at least one first functional site or group and at least one second functional group. The first and second functional groups can be identical or different. Thus, the second functional groups can be any of, for example, typical chemical reactive groups, such as hydroxyl (including phenolic hydroxy groups), carboxy, anhydride, aldehyde, ketone, amino, amine, amide, imine, imidine and derivatives and salts thereof, to mention some examples. Also electronegative bonds, such as double bonds, oxo or azo—bridges, can provide for bonding to the oxidized residues. Any group capable of achieving a bond to a functional agent is included. The bond can be based on ionic or covalent bonding or hydrogen bonding. The modifying agent can comprise a plurality of second functional groups.

In the modifying agents of the two kinds discussed above (Alternatives 2 and 3), the first and second functional sites are attached to a hydrocarbon residue, which can be a linear or branched aliphatic, cycloaliphatic, heteroaliphatic, aromatic or heteroaromatic. According to one preferred embodiment, aromatic compounds having 1 to 3 aromatic ring(s)—optionally forming a fused cyclic structure—are used. As a typical example, aminophenol can be mentioned, which contains a first functionality compatible with the oxidized phenolic or similar structure (the phenolic hydroxyl group) and a second functionality compatible with the functional groups of the conductive polymer (the amino function).

As a typical example of the above bifunctional modifying agents (Alternative 3), aminophenol can be mentioned, which contains a first functionality compatible with the oxidized phenolic structure (the phenolic hydroxyl group) and a second functionality, the amino group. Such a group is compatible, for example, with the functional groups of a conductive polymer of the polyaniline kind.

In the third step of the process applied to modifying agents according to Alternative 3, a functional agent is contacted with the modified fibre matrix containing a modifying agent bonded to the oxidized phenolic structures in the fibres.

Such functional agents can be any compound, which will introduce to the fibrous matrix novel properties. Above, reference has already been made to the embodiment in which an electrically conductive polymer is grafted to the fibre via the modifying agent. In this alternative, the modified fibre is contacted with the monomers of the electrically conductive polymer, which are polymerized in such a way that one end of the polymer chain is attached to the tagged matrix. As a result, an electrically conducting fibre is produced.

The functional agent can be contacted with the modified fibre in liquid phase—in solution or in suspension phase—under suitable conditions, normally dictated by the functional agent. In the case of conductive polymers and in situ polymerization thereof, the consistency of the reaction mixture is about 0.1 to 50% by weight, in particular about 1 to 20% by weight. The temperature is in the range of 5 to 100° C., typically about 10 to 85° C. Normally, ambient temperature (room temperature) or a slightly elevated temperature (20-80° C.) is preferred. According to an embodiment, the temperature is under 35° C., typically above zero and below room temperature, a typical reaction temperature being about 10 to 15° C. The pH of the aqueous medium is chosen as to favor polymerization. Typical pH values are in the acidic range.

All of the above three steps can be carried out in the same reaction medium. It is also possible to carry out the three (or two) steps of the process sequentially or simultaneously. The process steps can also be carried out by layering technique, e.g. on a web.

After the above processing, the modified fibre having new properties is generally separated from the liquid reaction and further used in target applications.

By means of the present invention, fibres can be designed to different purposes and functions. Some of the properties have already been discussed above, but summarizing it can be noted that the specific functions in the fibres include characteristics, such as hydrophilic or hydrophobic character. The characteristics may relate to heat resistance properties—the modified fibre may be heatproof, flame-retardant or V-resistant. The fibre may attain odor-inhibitory, biocompatible, biodegradable, soil-resisting characters. The characteristics may be related to charge and the fibre may be modified to be conductive, antistatic, insulative or acting as a sensor. The modified fibre may have antibacterial, antifungal or antimicrobial activity. The modifying agent may be a colouring or whitening agent.

The following non-limiting examples illustrate the invention:

### EXAMPLE 1a

Bonding of a Positively Charged Compound

5 g portion of spruce TMP was suspended in water. The pH of the suspension was adjusted to pH 4.5 by addition of acid. The suspension was stirred and the temperature was maintained at 20° C. Laccase dosage was 1000 nkat/g of pulp dry matter and the final pulp consistency was 7.5%. After 30 minutes laccase reaction, 0.33 mmol 3-hydroxytyramine hydrochloride/g of pulp dry matter was added to the pulp suspension. After 1 h total reaction time the pulp suspension was filtered and the pulp was washed thoroughly with water. For comparison purposes, reference treatments were carried out using the same procedure as described above but without addition of laccase, tyramine or both laccase and tyramine. The N-content of the pulp was analysed by a ESCA and by a modified Kjeldahl method from handsheets made of the treated pulps (Table 1).

TABLE 1
The effect of bonding of a positively charged, nitrogen containing
compound to TMP on the nitrogen content

| | ESCA | Kjeldahl |
|---|---|---|
| | (surface content | (total content |
| | of nitrogen, %) | of nitrogen, %) |
| REF | 0.10 | 0.06 |
| +tyramine | 0.29 | 0.05 |
| +laccase | 0.10 | 0.06 |
| +tyramine and laccase | 0.61 | 0.11 |

The above results demonstrate that it is possible to bond new compounds to pulp fibres by enzymatic means. The ESCA results also confirm that this type of modification is surface specific. The functional groups carried a positive charge.

### EXAMPLE 1b

Chemical Bonding of Positively Charged Compound

15 ml of 8.33% 3-hydroxytyramine hydrochloride water solution (1.25 g tyramine chloride) was added to 20 g of disintegrated TMP as an aerosol during 15 minutes in a high-consistency mixer. After addition of tyramine 3 g APS (ammonium persulfate) oxidant dissolved in 15 g of water was added as an aerosol during 15 minutes mixing period. After this the mixer was stopped and the pulp was let to stand for 30 minutes, whereafter the pulp was diluted to 2000 ml water, filtrated twice, and washed with 1000 ml of water. Reference treatments were carried out correspondingly but without addition of APS (water was added in the reference instead of APS). The N-content of the pulp was analysed by a modified Kjeldahl method. Total nitrogen content was higher in the bonded sample than in reference sample. The nitrogen analysis confirmed that a positively charged group was bound to the fibres.

### EXAMPLE 2

Bonding of a Whitening Compound to TMP

Betulinol dissolved in aceton and 0.1% thesit was bonded as described in example 1 to TMP. The obtained results showed that bonding of betulinol affected the colour of the fibres significantly.

The above results (examples 1 and 2) demostrate that it is possible to bond new compounds to pulp fibres by enzymatic means and thus to make tailor made fibres via this enzymatic functionalisation.

### EXAMPLE 3

Bonding of an Antimicrobial Compound to TMP

Chitosan was bonded to L-Dopa, which had been bonded to TMP as described in example 1. After bonding of L-Dopa to TMP, the treatment was continued by adding chitosan in acidic water and tyrosinase (1000 nkat/g). After two hours reaction time with tyrosinase the pulp suspension was filtered and the pulp was washed thoroughly with water. For comparison purposes, reference treatments were carried out. Improved antimicrobial properties were observed in the chitosan containing fibres as compared to the reference treated pulp.

### EXAMPLE 4

Bleached TMP was treated with galactose oxidase (2 h, pH 7, 1000 nkat/g). Carbonyl groups were formed on the surface of the fibres. The formed carbonyls were further converted to amines by reductive amination. Carbonyls were also successfully linked with other functional groups i.e. alcohols, polyvalent alcohols, amines and polyamines.

### EXAMPLE 5

Bonding of Hydrophobic Compound to Softwood Kraft Pulp

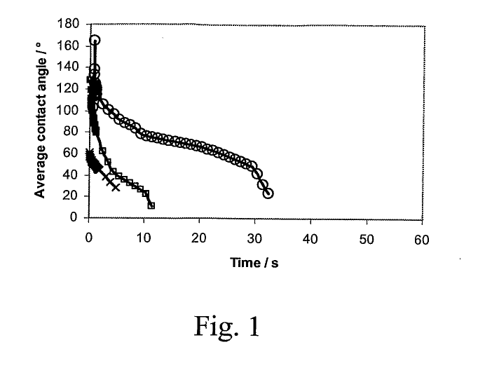

A 100 g portion of softwood kraft pulp was suspended in water. The pH of the suspension was adjusted to pH 4.5 by addition of acid. The suspension was stirred at 40° C. Laccase dosage was 1000 nkat/g of pulp dry matter and the final pulp consistency was 4%. After a 30 minutes laccase reaction, 0.12 mmol 3,4,5-trihydroxybenzoic acid dodecyl acid ester/g of pulp dry matter was added to the pulp suspension. After 2 h total reaction time the pulp suspension was filtered and the pulp was washed thoroughly with water. For comparison purposes, a reference treatment was carried out using the same procedure as described above but without addition of laccase and 3,4,5-trihydroxybenzoic acid dodecyl acid ester or only laccase. The hydrophobicity of the handsheet prepared from pulp analysed by contact angle measurement was considerably increased by laccase catalysed bonding of 3,4,5-trihydroxy-benzoic acid dodecyl acid ester as compared with the reference treated pulps (FIG. 1).

As the results show, the hydrophobicity of wood pulp can be considerably increased by enzyme catalysed bonding of hydrophobic compound, here 3,4,5-trihydroxybenzoic acid dodecyl acid ester, to pulp.

### EXAMPLE 6

Production of Conductive Fibre

A chemo-enzymatic treatment was started by mixing 20 g of cold-disintegrated TMP (pH ˜4.5) in a mixer at a consistency of 16% for 10 minutes at room temperature. Laccase (1000 nkat/g of pulp dry matter) was added as an aerosol during this time. After 30 min reaction an aqueous solution of 4-aminophenol, comprising 1.3 g aminophenol, 72 ml water and 8 ml 1 M HCl, was added. The added amount of 4-aminophenol was equivalent to 0.6 mmol 4-aminophenol/g pulp. After the addition, the pulp was mixed for 2 h at a pulp consistency of 10 wt-%.

Throughout the following steps, the suspension was stirred with a blade mixer:

290 ml of an aniline solution (containing 2 g of aniline and 17.2 g of DBSA) was added to the pulp suspension and 4.6 g of APS dissolved in water was added within 4 h. The pulp concentration was 3% after all additions. The pulp was additionally mixed for 12 h, thereafter the pulp was diluted to 2000 ml, filtrated twice, and washed with 400 ml of water.

After the treatments, handsheets were prepared from the pulps according to SCAN M5:76 on wire cloth. The handsheets were dried at room temperature. The surface resistencity (conductivity) of the handsheets was measured by using Premix SRM-110 and it was 10 exp 5 ohm/m². The nitrogen content of the samples was analysed by the Kjeldahl method, and N(1) was 1600 ppm and N(2) 1400 ppm.

### EXAMPLE 7

Production of Conductive Fibre by Chemical Means

A chemical treatment was started by mixing 20 g TMP (pH ˜4.5) in a mixer at a consistency of 17% for 10 minutes at RT. APS dissolved in water was added as an aerosol (0.075 g/g of pulp dry matter) during this time. An aqueous solution of 4-aminophenol (1.3 g aminophenol, 80 ml acidic water) was added (equivalent to 0.6 mmol 4-aminophenol/g pulp) and the pulp was mixed for 2 h. After the addition of the aminophenol solution, pulp consistency was 10

Throughout the following steps, the suspension was stirred:

290 ml of an aniline solution (containing 2 g of aniline and 17.2 g of DBSA) was admixed with the pulp suspension and 4.6 g of APS dissolved in water was added within 4 h. The pulp concentration was 3% after all additions. The pulp was additionally mixed for 12 h, where-after the pulp was diluted to 2000 ml, filtrated twice, and washed with 400 ml of water. Hand-sheets were prepared as in the previous examples. The surface resistivity of the handsheets was measured by using Premix SRM-110 and it was 10 exp 5 ohm/m². The nitrogen content of the samples analysed by the Kjeldahl method was 1100 ppm.

### EXAMPLE 8

Dried TMP and kraft pulp handsheets were treated with laccase (1000 nkat/g) by spraying. Thereafter the handsheest were sprayed with a isoeugenol solution to give a isoeugenol consentration of 40 mg isoeugenol/g pulp. The handsheets were dried and the and the hydrophobicity of the handsheets was analysed by contact angle measurement. The hydrophobicity of the handsheets was increased due to the treatment.

1. A process for producing a fibrous material having a modified structure comprising a lignocellulosic material with phenolic or similar structural groups and a modifying agent, said process comprising the steps of
oxidizing phenolic or similar structural groups of the lignocellulosic matric to provide an oxidized fibre material, and
contacting the oxidized fibre material with a modifying agent containing at least one first functional portion, which is compatible with the oxidized fibre material, said modifying agent being capable of providing the lignocellulosic fibre material with properties foreign to the native fibre.

2. The process according to claim 1, wherein the lignocellulosic fibrous matrix is reacted with an oxidizing agent in the presence of a substance capable of catalyzing the oxidation of phenolic or similar structural groups by said oxidizing agent.

3. The process according to claim 1, wherein the modifying agent is activated with an oxidizing agent.

4. The process according to claim 1, wherein the modifying agent is selected from the group of hydrophobic agents, whitening or (colour retention agents), signal agents, active gas traps, antimicrobial compounds, colouring agents, pigments, agents capable of dissipating incident radiation, sizing agents, retention agents, or one carrying several of these properties.

5. A process for producing a fibre material having a modified structure comprising a lingo cellulosic fibrous matrix with phenolic or similar structural groups and a modifying agent, said process comprising the steps of
oxidizing phenolic or similar structural groups of the lignocellulosic matric to provide an oxidized fibre material, and
contacting the oxidized fibre material with a modifying agent containing at least one first functional portion, which is compatible with the oxidized fibre material, and at least one second portion having new functional properties in order to provide a lignocellulosic fibre material exhibiting properties foreign to the native fibre.

6. The process according to claim 5, wherein the lignocellulosic fibrous matrix is reacted with an oxidizing agent in the presence of a substance capable of catalyzing the oxidation of phenolic or similar structural groups by said oxidizing agent.

7. The process according to claim 5, wherein the modifying agent comprises at least one functional group, which bonds to the oxidized lignocellulosic matrix, and a hydrocarbon tail, which is saturated or unsaturated.

8. The process according to claim 5, wherein the hydrocarbon tail contains a minimum of two, preferably at least three carbon atoms, and extends to up to 30 carbon atoms, in particular 24 carbon atoms.

9. The process according to claim 5, wherein the second groups comprises a group capable of carrying or capable of being modified for carrying a negative or positive charge.

10. The process according to claim 5, wherein the second groups comprises a group capable of carrying or capable of being modified for antibacterial, antifungal or antimicrobial effect.

11. The process according to claim 5, wherein the second groups comprises a group capable of carrying or capable of being modified for heatproof, flame-retardant or UV-resistant.

12. The process according to claim 5, wherein second groups comprises a group capable of carrying or capable of being modified for conductive, antistatic, insulative character or is acting as a sensor

13. The process according to claim 5, wherein the second groups comprises a group capable of carrying or capable of being modified for changing the colour of the fibre.

14. The process according to claim 5, wherein the second group comprises properties that participate in developing colour.

15. The process according to claim 5, wherein the modifying agent is selected from the group of betuline, betulinol, kaempherol and quercetin or their derivatives or structural analogues.

16. A process for producing a fibre material having a modified structure comprising a lingo-cellulosic fibrous matrix having phenolic or similar structural groups and a modifying agent, said process comprising the steps of
oxidizing phenolic or similar structural groups of the lignocellulosic matric to provide an oxidized fibre material,
contacting the oxidized fibre material with a modifying agent containing at least one first functional group, which is compatible with the oxidized fibre material, and at least one second functional group in order to provide a lignocellulosic fibre material having a modified surface,
contacting the lignocellulosic fibre material with a functional agent, and
bonding a functional agent to the modified surface of the fibre material in order to impart to the fibre material new functional properties, foreign to the native fibre, derivable from the functional agent.

17. The process according to claim 16, wherein the lignocellulosic fibrous matrix is reacted with an oxidizing agent in the presence of a substance capable of catalyzing the oxidation of phenolic or similar structural groups by said oxidizing agent.

18. The process according to claim 17, wherein the modifying compound is a bifunctional compound containing at least one first functional portion or group and at least one second functional group, the second functional group being selected from the group of hydroxyl (including phenolic hydroxy groups), carboxy, anhydride, aldehyde, ketone, amino, amine, amide, imine, imidine and derivatives and salts thereof.

19. The process according to claim 1, wherein the substance capable of catalyzing the oxidation of phenolic groups is an enzyme.

20. The process according to claim 19, wherein the enzyme capable of catalyzing the oxidation of phenolic or similar structural groups is selected from the group of peroxidases and oxidases.

21. The process according to claim 20, wherein the enzyme is selected the group of laccases (EC 1.10.3.2), catechol oxidases (EC 1.10.3.1), tyrosinases (EC 1.14.18.1), bilirubin oxidases (EC 1.3.3.5), horseradish peroxidase (EC 1.11.1.7), manganase peroxidase (EC1.11.1.13), lignin peroxidase (EC 1.11.1.14), hexose oxidase (EC 1.1.3.5), galactose oxidase (EC 1.1.3.9) and lipoxygenase.(EC 1.13.11.12).

22. The process according to claim 20, wherein the enzyme dosage is from 1 to 100,000 nkat/g, preferably 10-500 nkat/g, and it is employed in an amount of 0.0001 to 10 mg protein of dry matter.

23. The process according to claim 1, wherein the oxidizing agent is selected from the group of oxygen and oxygen-containing gases, such as air, or hydrogen peroxide.

24. The process according to claim 23, wherein oxygen or oxygen-containing gas is introduced into the aqueous slurry during the reaction.

25. The process according to claim 1, wherein the reaction of step (a) is carried out in an aqueous or dry phase at a consistency of 1 to 95% by weight of the fibre material.

26. The process according to claim 1, wherein the reaction is carried out at temperature 5-100° C.

27. The process according to claim 1, wherein the reaction is carried out on a fibrous web.

28. The process according to claim 1, wherein the lignocellulosic fibre material is reacted with a chemical oxidizing agent capable of catalyzing the oxidation of phenolic or similar structural groups to provide an oxidized fibre material.

29. The process according to claim 1, wherein the chemical oxidizing agent is hydrogen peroxide, Fenton reagent, organic peroxidase, potassium permanganate, ozone and chloride dioxide, ammoniumpersulphate (APS) or an inorganic transition metal salts.

30. The process according to claim 1, wherein radical forming radiation capable of catalyzing the oxidation of phenolic or similar structural groups is used to provide an oxidized fibre material.

31. The process according to claim 1, wherein the reaction steps are carried out sequentially or simultaneously.

32. A method of producing white-coloured fibres from a raw-material comprising a lingo-cellulosic fibrous matrix, the method comprising the steps of
oxidizing phenolic or similar structural groups of the lignocellulosic matric to provide an oxidized fibre material, and
contacting the oxidized fibre material with a whitening agent containing at least one first functional portion, which is compatible with the oxidized fibre material, said whitening agent being capable of providing the lignocellulosic fibre material with white colour.

33. The method according to claim 31, wherein the whitening agent is an organic substance, which is capable of rendering the fibre a white colour.

34. The method according to claim 32, wherein the whitening is selected from betuline, betulinol, kaempherol and quercetin or their derivatives or structural analogues.
